(19) United States
(12) Patent Application Publication
(10) Pub. No.: US 2009/0027228 A1
(43) Pub. Date: Jan. 29, 2009

(54) System and Method for Wirelessly Communicating Battery Status

(76) Inventors: Nicole D. Tricoukes, Seaford, NY (US); Thomas K. Roslak, Northport, NY (US); Andrew M. Doorty, Northport, NY (US)

Correspondence Address: Fay Kaplun & Marcin, LLP/ Motorola, 150 Broadway Suite 702, New York, NY, 10038, US

(21) Appl. No.: 11/782,203

(22) Filed: Jul. 24, 2007

(51) Int. Cl. G08C 19/16

(52) U.S. Cl. 340/870.01

(57) ABSTRACT

Described is a system, an apparatus, and a method for wirelessly communicating battery status. The apparatus may include at least one contact receiving power from a battery; a wireless component communicating with a wireless communication device joined to a surface of the battery; and a processor connected to the wireless component and monitoring the battery in order to one of generate and collect battery status information. The processor is capable of causing the wireless component to transmit the battery status information to the wireless communication device of the battery.

### FIELD OF INVENTION

The present invention generally relates to a device embedded in a removable battery of an electronic device, in which the embedded device wirelessly communicates to an antenna incorporated in the device information concerning the status of the battery.

### BACKGROUND

Removable batteries are often returned for service or replacement, since they are often subject to abuse, are incorrectly charged (e.g., by allowing the battery to go flat, not initiating the charging correctly as in shallow charging), are subject to counterfeiting, are damaged by severe physical shock, or are exposed to thermal extremes.

Companies that incorporate removable batteries in their device products need to be able to determine the usage trends for the devices over long periods of time to identify critical situations in order to improve battery or device designs, or document a record information on the battery use that could be used to avoid liability. For instance, such information could be useful to a company that has been sued on account of an alleged battery malfunction causing a fire.

Current smart batteries rely on a direct, wired connection from the battery to a collection source, but this limits the usefulness of the information gathering ability of the battery, on account of environmental damage to the wired connection arising from electrostatic discharge, erosion, or other internal or external causes.

### SUMMARY OF THE INVENTION

The present invention relates to a system, an apparatus, and a method for wirelessly communicating battery status. The apparatus may include at least one contact receiving power from a battery; a wireless component communicating with a wireless communication device joined to a surface of the battery; and a processor connected to the wireless component and monitoring the battery in order to one of generate and collect battery status information. The processor is capable of causing the wireless component to transmit the battery status information to the wireless communication device of the battery.

The present invention also relates to a battery which may include a body containing a source of electrical charge; and a wireless communication device joined to a surface of the body and including a memory for storing information relating to an operation of the battery.

The method according to the present invention may include the following steps. A battery is connected to a device. The battery includes a wireless communication device joined thereto. An operation of the battery is monitored in order to one of generate and collect battery status information. The battery status information is transmitted to the wireless communication device. The battery status information is stored in a memory of the wireless communication device.

### BRIEF DESCRIPTION OF THE DRAWINGS

FIG. 1 shows an exemplary embodiment of a device battery incorporating an embedded RFID tag.

FIG. 2 shows a block diagram of an electronic device incorporating the battery of FIG. 1.

FIG. 3 shows a block diagram of an electronic device capable of scanning a battery provided with an embedded RFID tag and storing the information read from the tag.

FIG. 4 represents a method showing how the device of FIG. 2 monitors stores battery performance information in an RFID tag embedded in the battery of the FIG. 2 device.

FIG. 5 represents a method showing how the device of FIG. 3 scans the battery status information stored in the RFID tag of FIG. 1.

### DETAILED DESCRIPTION

The present invention may be further understood with reference to the following description of exemplary embodiments and the related appended drawings, wherein like elements are provided with the same reference numerals. The present invention generally relates to a system and method involving a device embedded in or on a battery of an electronic device, in which the embedded device wirelessly transmits to an antenna located in the electronic device information pertaining to the status of the battery.

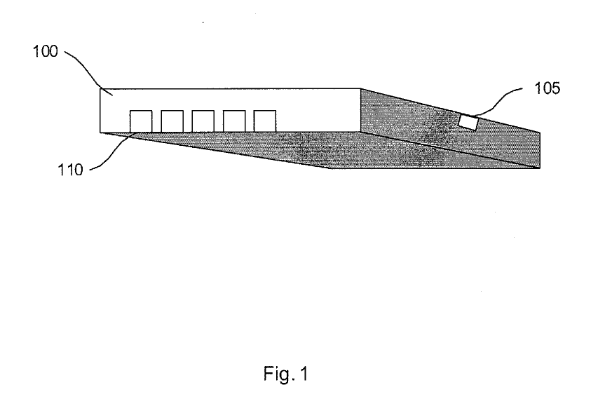

FIG. 1 shows an exemplary battery 100 having electrical contacts 110 for connection with an electronic device in order to deliver power to the electronic device components. The battery 100 may be what is typically used in portable electronic devices such as cellular telephones, personal digital assistants (PDAs), laptop computers, bar code scanners, etc. For instance, as far as its power supplying capacity is concerned, battery 100 may be any type of battery, including a lithium-ion battery that is typically used in mobile electronic devices.

Embedded in a surface of battery 100 is an RF chip serving as an RFID tag 105. RF chip 105 may be embedded in battery 100 through any suitable manufacturing technique, such as injection molding, surface mounting through an adhesive, epoxy bonding, fastening, glob top attachment, or joining as a potted module, etc. Alternatively, the RF chip 105 may be affixed to the battery 100 after the battery has been manufactured, for instance, by any suitable adhesive. Although embedded in or otherwise affixed to battery 100, RF chip 105 is not electrically connected to battery 100. Chip 105 does not communicate data with, nor receive power from, battery 100. Instead, RF chip 105 is a passive device that does not rely on any battery to power itself. Using know techniques, the power used to energize chip 105 is derived by the chip 105 from an interrogation signal, through, for example, inductive or capacitive techniques. In addition, RF chip includes a memory for storing information related to the status of the battery to which it is joined. Although the embodiment discussed herein is based on an RF chip 105, any wireless device capable of storing and communicating battery status information, and capable of being sized small enough to avoid obstructing the electrical coupling of a battery to its respective device, can serve as chip 105. One example of an RF chip that may be used in the present invention is the μ-Chip manufactured by Hitachi, Ltd.

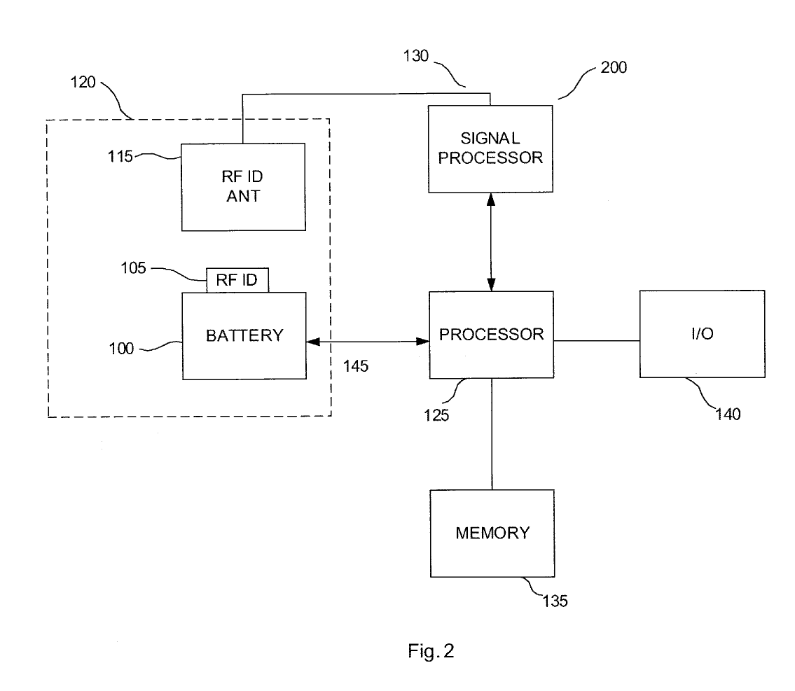

FIG. 2 shows a block diagram of an electronic device 200 according to the present invention. Device 200 includes an I/O unit 140 that may include such typical input/output components as a keyboard, keypad, display, speaker, microphone, data capture module (e.g., bar code reader), and graphical user interface (GUI). Battery 100 of FIG. 1 is shown inserted in a battery compartment 120 of the electronic device. Alternatively, battery 100 may be of a type that is not completely enclosed by a compartment, but that instead is contoured in such a way as to serve as at least part of an external profile surface of the device 200. For instance, the external surface of battery 100, when joined to electronic device 200, may serve as a substantial portion of the back surface of the electronic device 200.

In FIG. 2, battery 100 has a wired data link 145 through which processor 125 monitors and collects information regarding battery performance, using techniques know in the art. The software instructions for this data collection process may be stored in memory 135, which may comprise a EEPROM, for instance, or the software may be stored directly in processor 125. Processor 125, either automatically or via a command entered through I/O unit 140, collects battery statistics, such as usage profiles, charging profiles, data on temperature exposure, actual charge capacity, and other information pertaining to maintenance or of interest to the service, use or reliability of the system. This could include such data as acceleration, drop shock, number of power cycles, number of insertions, number of docking, docking cycles etc. After the processor 125 collects this information, it formats it according to any suitable data structure, such as a file or log structure, and transmits it, after suitable signal processing (e.g., modulation, noise filtering, etc.), via RF antenna 115 to RF chip 105 for storage. Although the embodiment of FIG. 2 shows antenna 115 and chip 105 communicating with each other through RF, any suitable wireless medium can serve as the basis through which such communication occurs. Examples of alternative wireless communication mediums include inductive, capacitive, infrared, etc. Moreover, antenna 115 may serve not only as a transmitter, but may serve as a receiver as well. For instance, in order to ensure that the battery status data has been stored correctly on RF chip 105, processor 125 may transmit through antenna 115 an interrogation signal that causes RF chip 105 to extract from its own memory the stored status information and transmit it to device 200 via antenna 115. Thus, by storing the battery performance data in RF chip, the present invention provides a separate and failsafe battery diagnostic system. As an alternative to using RF communication, the device 200 may communicate with RF chip through inductive, capacitive, infrared (IR), or other wireless techniques.

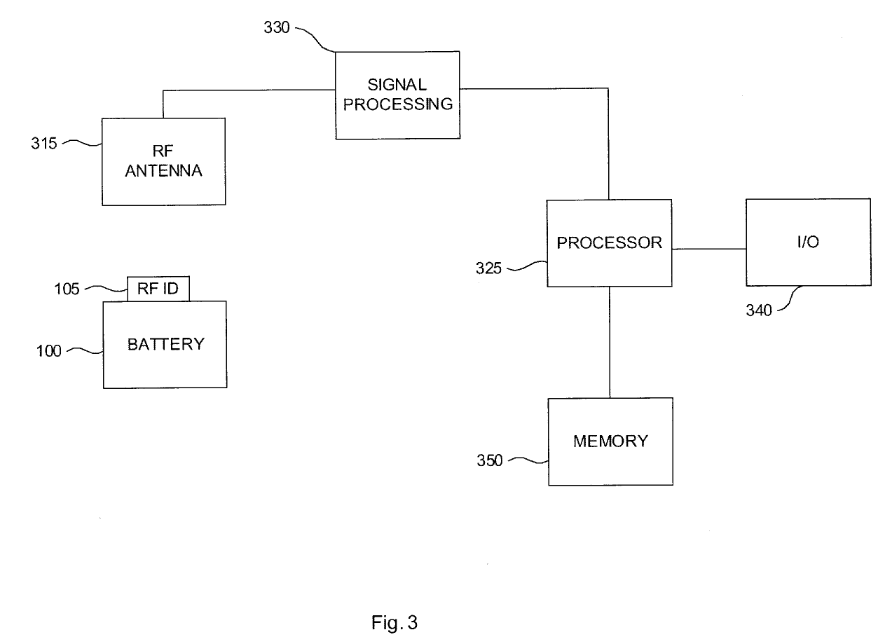

FIG. 3 shows a block diagram of a battery status reader 300. Battery status reader 300 may be either a mobile or non-mobile apparatus of a back-end location of a company, where batteries that have been returned for servicing or for exchange with a new battery are analyzed based on the status information stored in RF chip 105. For instance, reader 300 may be located at a computer manufacturing company in order to scan the RF chips of laptop batteries that customers have returned due to some sort of malfunction. As explained above, the apparatus 300 may be embodied as a fixed computer coupled with a scanning arrangement suitable for reading RF chip 105, or it may be a similarly constructed device embodied on a handheld platform. A user of apparatus 300 may enter a command via I/O unit 340 to scan a battery placed within scanning range of RF antenna 315. As explained above, the wireless scanning medium need not be RF, but may instead be inductive, capacitive, IR, etc. After battery status information is read by antenna 315 and demodulated, filtered, etc., by signal processor 330, processor 325 analyzes the status information and stores it in memory 350, which may comprise a database storing status information for a large multitude of batteries. After analyzing the data from RF chip 105, the processor 325 may recommend a particular course of action, such as issuing a replacement for a customer. The information stored in memory 350 may be used by battery designers as a basis for improved designs in future batteries.

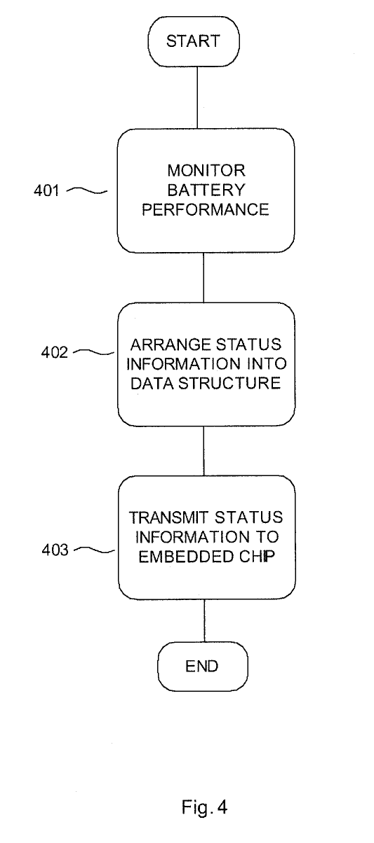

FIG. 4 illustrates a method showing the operation of device 200. First, the processor 125 monitors the battery performance to collect and/or generate information pertaining to such factors as battery temperature, charge levels, charge capacity over time, and other typical factors indicative of battery functioning (step 401). Next, processor 125 arranges the battery status information into a particular data structure, such as a file or log structure (step 402). After the information is formatted, it is transmitted wirelessly to embedded chip 105 (step 403), which stores the information in its own memory.

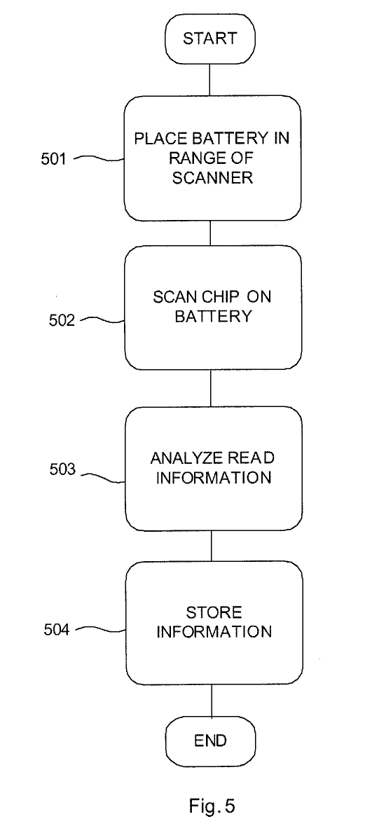

FIG. 5 illustrates a method showing the operation of battery status reader 300. After the battery 100 is placed in range of the antenna 315 (step 501), the processor 325, either automatically or via a command entered through I/O unit 340, reads the embedded chip 105 (step 502). This reading may involve the transmission of an interrogation signal to the chip 105, which responds by transmitting the battery status information from its own memory to reader 300. The processor 325 then analyzes the read information (step 503) and stores it in memory 350 (step 504).

Although the present invention has been described in connection with an RF chip being joined to a battery for the purpose of storing information pertaining to the performance of the battery and wirelessly transmitting that information to another device, the present invention is applicable to a wireless communication chip being non-electrically joined to any type of electronic device for the purpose of storing and communicating performance information about that device. Moreover, the wireless communication device need not be joined to an external surface of the battery or electronic device, but may instead be joined to any available internal surface as well.

What is claimed is:

1. A battery, comprising:
a body containing a source of electrical charge; and
a wireless communication device joined to a surface of the body and including a memory for storing information relating to an operation of the battery.

2. The battery of claim 1, wherein the wireless communication device is embedded in the surface of the body.

3. The battery of claim 1, wherein the wireless communication device is affixed onto the surface of the body.

4. The battery of claim 1, wherein the wireless communication device transmits the information as one of an RF signal, an inductive signal, a capacitive signal, and an IR signal.

5. The battery of claim 1, wherein the wireless communication device is a passive device.

6. The battery of claim 1, wherein the wireless communication device lacks any electrical connection to the body.

7. An apparatus, comprising:
at least one contact receiving power from a battery;
a wireless component communicating with a wireless communication device joined to a surface of the battery; and
a processor connected to the wireless component and monitoring the battery in order to one of generate and collect battery status information, wherein the processor is capable of causing the wireless component to transmit the battery status information to the wireless communication device of the battery.

8. The apparatus of claim 7, wherein the wireless communication device is embedded in the surface of the battery.

9. The apparatus of claim 7, wherein the wireless communication device is affixed onto the surface of the battery.

10. The apparatus of claim 7, wherein the wireless communication device of the battery transmits the information as one of a RF signal, an inductive signal, a capacitive signal, and an IR signal.

11. The apparatus of claim 7, wherein the wireless component transmits the information as one of an RF signal, and inductive signal, a capacitive signal, and an IR signal.

12. The apparatus of claim 7, wherein the wireless communication device of the battery is a passive device.

13. The apparatus of claim 7, wherein the wireless communication device of the battery lacks any electrical connection to the battery.

14. A method, comprising:
connecting a battery to a device, the battery including a wireless communication device joined thereto;
monitoring an operation of the battery in order to one of generate and collect battery status information;
transmitting the battery status information to the wireless communication device; and
storing the battery status information in a memory of the wireless communication device.

15. The method as recited in claim 14, further comprising formatting the battery status information.

16. The method of claim 14, wherein the wireless communication device is embedded in the surface of the battery.

17. The method of claim 14, wherein the wireless communication device is affixed onto the surface of the battery.

18. A method, comprising:
scanning a wireless communication device joined to a battery, wherein the wireless communication device lacks any electrical connection to the battery and stores battery status information pertaining to a performance of the battery;
analyzing the battery status information produced by the scanning; and
storing the battery status information.

19. A system, comprising:
means for connecting a battery to a device, the battery including a wireless communication device joined thereto;
means for monitoring an operation of the battery in order to one of generate and collect battery status information;
means for transmitting the battery status information to the wireless communication device; and
means for storing the battery status information in a memory of the wireless communication device.

20. A system, comprising:
means for scanning a wireless communication device joined to a battery, wherein the wireless communication device lacks any electrical connection to the battery and stores battery status information pertaining to a performance of the battery;
means for analyzing the battery status information produced by the scanning; and
means for storing the battery status information.

21. A device, comprising:
a housing including at least one electronic circuit; and
a wireless communication device joined to a surface of the body and including a memory for storing information relating to an operation of the device.
